(19) United States
(12) Patent Application Publication
(10) Pub. No.: US 2008/0144910 A1
(43) Pub. Date: Jun. 19, 2008

(54) IMAGE FUSION VISUALIZATION

(76) Inventor: Anke Weissenborn, Munchen (DE)

Correspondence Address: RENNER, OTTO, BOISSELLE & SKLAR, LLP, Nineteenth Floor, 1621 Euclid Avenue, Cleveland, OH, 44115-2191, US

(21) Appl. No.: 11/956,363

(22) Filed: Dec. 14, 2007

Related U.S. Application Data
(60) Provisional application No. 60/887,977, filed on Feb. 2, 2007.

(30) Foreign Application Priority Data
Dec. 14, 2006 (EP) 06025926

(51) Int. Cl. G06K 9/00

(52) U.S. Cl. 382/131

(57) ABSTRACT

An apparatus and method for displaying at least two different image series obtained from the same region of interest of an object include fusing the a first image series and a second image series to obtain a spatial relationship between the first and second image series. Then, a first viewing operation performed on the first image series is automatically performed on the second image series.

### RELATED APPLICATION DATA

This application claims priority of U.S. Provisional Application No. 60/887,977 filed on Feb. 2, 2007, which is incorporated herein by reference in its entirety.

### FIELD OF THE INVENTION

The present invention relates to an apparatus and a method for the visualization of fused images.

### BACKGROUND OF THE INVENTION

CT scanners, like other medical scanners, define an examination region or scan circle in which the patient or other subject to be imaged is disposed. A beam of radiation is transmitted across the scan circle from an X-ray source to oppositely disposed radiation detectors. The segment of the beam impinging on a sampled detector defines a ray extending between the source and the sampled detector. The source or beam of radiation is rotated around the scan circle such that data from a multiplicity of rays crisscrossing the scan circle is collected. The sampled data is backprojected to an image memory, which is commonly described as a two dimensional array of memory elements. Each memory element stores a CT number indicative of the transmission or attenuation of the rays attributable to a corresponding incremental element within the scan circle. The data from each ray that crossed a given incremental element of the scan circle contributes to the corresponding CT number, e.g., the CT number for each memory element of the resultant image is the sum of contributions from the multiplicity of rays which passed through the corresponding incremental element of the scan circle. This data can be used to generate a three dimensional CT data set of the imaged examination region or scan circle.

Using such a three dimensional data set, a surgeon can examine a specific part of a body of a patient. While CT scanners enable detection of hard material, such as bones, with great detail, they have short comings with respect to imaging of soft tissue.

To provide a surgeon with additional information regarding the examination region or scan circle, a different imaging modality, such as magnetic resonance imaging (MRI), for example, can be used. Such other imaging modalities can provide an enhanced three dimensional data set for soft tissue.

If a surgeon has to consider the data obtained from at least two different imaging modalities, it might be confusing for a surgeon to correlate the respective images from the different imaging modalities or obtained from the same imaging modality at two or more different times.

### SUMMARY OF THE INVENTION

The present invention provides a system and method that enables the use of images or data sets obtained from at least two different diagnostic imaging apparatus, wherein a viewing operation in one data set is automatically performed in the other data set. The invention finds particular application in conjunction with computer tomography (CT) scanners and magnetic resonance (MR) scanners. However, it is to be appreciated that the invention may also find application in conjunction with images created from other modalities, including positron emission scanner and other types of images of diagnostic imaging apparatus.

According to one aspect of the invention, there is provided an apparatus and method for displaying a first image series and a second image series different from the first image series, said first and second image series obtained from the same region of interest of an object, comprising: fusing the first image series and the second image series to obtain a spatial relationship between the first and second image series; performing a first viewing operation on the first image series; and automatically performing the first viewing operation on the second image series.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

The forgoing and other embodiments of the invention are hereinafter discussed with reference to the drawings.

### BRIEF DESCRIPTION OF THE DRAWINGS

The forgoing and other features of the invention are hereinafter discussed with reference to the drawings.

FIG. 1 is a flow chart illustrating an exemplary method in accordance with the invention.

FIG. 2 is a block diagram of an exemplary computer system that can be used to implement the method of FIG. 1.

### DETAILED DESCRIPTION

In accordance with the present invention, a parallel aligned visualization of multiple image series is obtained from at least two different imaging modalities. The image series obtained from the different imaging modalities preferably are three dimensional data sets, and are exactly fused in all three planes. An exact fusion, for example, can be obtained by automatic image fusion or manual alignment, which can be performed by an experienced person. After having the multiple image series exactly fused, at least one image series can be manipulated (e.g., zoomed, scrolled, rotated, etc.) for viewing in all three planes. The visual operations performed on one image series can be automatically transferred or translated into one or more other image series, so that viewing operations such as scrolling or zooming performed on one image series is automatically performed on the other image series. Thus, if a surgeon scrolls and zooms to a specific region of interest, for example, in a CT data set, then the same region of interest is zoomed and scrolled in one or more different data sets (e.g., MR, data sets). This enables the surgeon to easily correlate the image information of two or more different data sets.

In the same manner, segmented objects, marks, points, lines, volumes or trajectories that have been calculated and/or drawn in one image series can be automatically visualized in parallel in a different or multiple image series in all three planes or in 3D reconstructions. After such an operation is performed in only a single one of the fused different image series, it is possible to switch objects, marks, points on and off in parallel in all image series.

Thus, different image series of a patient can be easily visualized and aligned in an axial, coronal and sagittal view. This enables improved evaluation of pathologies, important anatomical structures and easy and comfortable handling of the different image series. Segmented objects can be easily visualized in all three planes and within all available image series. Further, drawings or marking scan be added to the image series to assist in identifying certain features found therein.

Further, increases in size and volume changes of certain areas or objects can be easily visualized or calculated. Intraoperative images can be matched and compared easily to pre-operative pictures. The matching of intraoperative images to pre-operative image series allows the convenient comparison of the operating room (OR)-progress.

A method and an apparatus are provided that improve the perception of three-dimensional data sets obtained from the same or different imaging modalities at two or more different times. The above-mentioned process of a parallel aligned visualization of multiple image series also can be applied to image series obtained by the same or different imaging modalities, wherein image series were acquired at two or more different times.

This is advantageous, for example, if a first examination is made at a first time, e.g., by obtaining an MR or CT scan, and a second examination is made at a second time, e.g., by again obtaining an MR or CT scan of the same body or structure, to easily detect or visualize changes of the examined region or body. If, for example, a tumor is to be observed, the growth of the tumor can be visualized. The at least two image series obtained at two different times can be fused to improve the perception of the change of the imaged object or structure.

The term fusion as used in this application includes, but is not restricted to, combining of sensory or image data or data derived from sensory or image data from separate sources or the same source at the same or different times, such that the resulting information is preferably in some sense better than would be possible when these sources were used individually or separately. The term better in that case can mean more accurate, more complete, or can refer to the result of an imaging view, such as stereoscopic vision. The data sources for the fusion process do not have to originate from identical sensors, such as the same scanners or cameras. Further, information sources, like a priori knowledge about the environment and/or human input, can be used for fusion.

Image fusion methods can be broadly classified into two approaches; spatial domain fusion and transform domain fusion. Fusion methods such as averaging, Brovey method, principal component analysis (PCA) and in hue-saturation (IHS) based methods fall under spatial domain approaches.

A possible disadvantage of spatial domain approaches is that they can produce spatial distortion in the fuse image. Such spatial distortion, however, is not an issue with transform domain approaches. Examples of transform domain approaches include discrete wavelet transformation (DWT), Laplacian pyramid, and curvelet transformations.

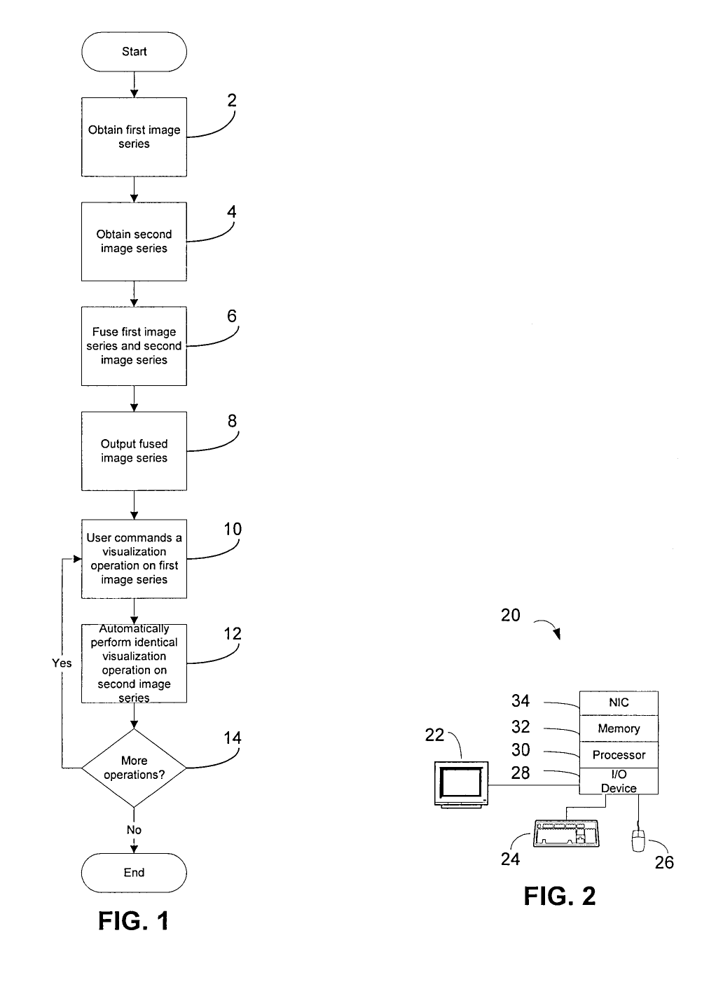

Referring to FIG. 1, there is shown a flow chart that includes exemplary steps, functions and methods that may be carried out in accordance with the invention. The flow chart includes a number of process blocks arranged in a particular order. As should be appreciated, many alternatives and equivalents to the illustrated steps may exist and such alternatives and equivalents are intended to fall within the scope of the claims appended hereto. Alternatives may involve carrying out additional steps or actions not specifically recited and/or shown, carrying out steps or actions in a different order from that recited and/or shown, and/or omitting recited and/or shown steps. Alternatives also include carrying out steps or actions concurrently or with partial concurrence.

Beginning at block 2, a first image series is obtained. The image series may be an MR data set, CT data set, or any other data set obtained via an imaging modality. The first image series may have been obtained in advance, in which case the first image series may be stored in memory of a computer (FIG. 2). Alternatively, the first image series may be obtained intraoperatively and stored in memory of the computer.

At block 4, a second image series is obtained. The second image series may be an image series obtained via a different imaging modality than that of the first image series. For example, if the first image series was obtained via MRI, then the second image series may be obtained via computer tomography (CT). Alternatively, both the first and second image series may be the same type of data sets (e.g., both may be MRI data sets). The second image series, like the first image series, may be obtained in advance of performing a medical procedure or intraoperatively.

Moving now to block 6, the first image series and the second image series are fused. The image series may be fused, for example, using any one of a number of different image fusion techniques, including spatial domain fusion techniques and/or transform domain fusion techniques. The fused first and second image series then are output, for example, on a display device as indicated at block 8.

At block 10, a visualization operation is performed on the first image series. The image visualization operation, for example, may be a zoom command (magnify the image data set), a rotate command (rotate the data set about an axis), a pan command (e.g., scroll or move the data set left, right, up, down, etc.). A visualization operation also may include segmenting the data set (e.g., cutting out a specific portion of the data set), shading, colorizing, etc. Such visualization operations are typically performed by a surgeon or other medical personnel so as to focus in on a particular area of the data set (e.g., on a tumor).

At block 12, the visualization operation performed on the first image series is automatically performed on the second image series. Then at block 14, if additional visualization operations are performed in the first image series, blocks 10 and 12 are repeated.

For example, if the surgeon performs a zoom operation so as to focus on a specific area of the first image series, then a corresponding zoom operation is automatically performed on the second image series. Then, if the surgeon performs a segment operation on the first image series, the same segment operation is automatically performed on the second image series. By automatically performing the same visualization operation on the second image series, the surgeon can easily correlate the regions from the first image series with the corresponding regions of the second image series.

Moving now to FIG. 2 there is shown a block diagram of an exemplary computer system 20 that may be used to implement the method described herein. The computer 20 may include a display 22 for viewing system information, and a keyboard 24 and pointing device 26 for data entry, screen navigation, etc. A computer mouse or other device that points to or otherwise identifies a location, action, etc., e.g., by a point and click method or some other method, are examples of a pointing device 26. Alternatively, a touch screen (not shown) may be used in place of the keyboard 24 and pointing device 26. The display 22, keyboard 24 and mouse 26 communicate with a processor via an input/output device 28, such as a video card and/or serial port (e.g., a USB port or the like).

A processor 30, such as an AMD Athlon 64® processor or an Intel Pentium IV® processor, combined with a memory 32 execute programs to perform various functions, such as data entry, numerical calculations, screen display, system setup, etc. The memory 32 may comprise several devices, including volatile and non-volatile memory components. Accordingly, the memory 32 may include, for example, random access memory (RAM), read-only memory (ROM), hard disks, floppy disks, optical disks (e.g., CDs and DVDs), tapes, flash devices and/or other memory components, plus associated drives, players and/or readers for the memory devices. The processor 30 and the memory 32 are coupled using a local interface (not shown). The local interface may be, for example, a data bus with accompanying control bus, a network, or other subsystem.

The memory may form part of a storage medium for storing information, such as application data, screen information, programs, etc., part of which may be in the form of a database. The storage medium may be a hard drive, for example, or any other storage means that can retain data, including other magnetic and/or optical storage devices. A network interface card (NIC) 34 allows the computer 20 to communicate with other devices.

A person having ordinary skill in the art of computer programming and applications of programming for computer systems would be able in view of the description provided herein to program a computer system 20 to operate and to carry out the functions described herein. Accordingly, details as to the specific programming code have been omitted for the sake of brevity. Also, while software in the memory 32 or in some other memory of the computer and/or server may be used to allow the system to carry out the functions and features described herein in accordance with the preferred embodiment of the invention, such functions and features also could be carried out via dedicated hardware, firmware, software, or combinations thereof, without departing from the scope of the invention.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method for displaying a first image series and a second image series different from the first image series, said first and second image series obtained from the same region of interest of an object, comprising:
fusing the first image series and the second image series to obtain a spatial relationship between the first and second image series;
performing a first viewing operation on the first image series; and
automatically performing the first viewing operation on the second image series.

2. The method according to claim 1, wherein the first viewing operation is at least one of scrolling, turning or zooming.

3. The method according to claim 1, wherein performing the first viewing operation on the first image series includes performing at least one of segmenting objects or marks in the first image series, identifying points, lines or trajectories in the first image series, calculating volumes in the first image series, drawing objects in the first image series, or calculating a property of objects in the first image series.

4. The method according to claim 3, wherein performing the first viewing operation on the second image series includes performing the first viewing operation on the second image series in parallel with performing the first viewing operation on the first image series.

5. The method according to claim 1, wherein performing the first viewing operation on the first image series and automatically performing the first viewing operation on the second image series includes performing both viewing operations in parallel.

6. A computer program embodied on a computer readable medium for displaying a first image series and a second image series different from the first image series, said first and second image series obtained from the same region of interest of an object, comprising:
code that fuses the a first image series and a second image series to obtain a spatial relationship between the first and second image series;
code that performs a first viewing operation on the first image series; and
code that automatically performs the first viewing operation on the second image series.

7. An apparatus for displaying a first image series and a second image series different from the first image series, said first and second image series obtained from the same region of interest of an object, comprising:
a processor and memory; and
logic stored in memory and executable by the processor, said logic including
logic that fuses the a first image series and a second image series to obtain a spatial relationship between the first and second image series;
logic that performs a first viewing operation on the first image series; and
logic that automatically performs the first viewing operation on the second image series.

8. The apparatus according to claim 7, further comprising a display device for displaying the first and second image series.

9. The apparatus according to claim 7, wherein the logic that performs the first viewing operation in the first image series includes logic that zooms in or out of the first image series, or logic that rotates the first image series about an axis, logic that scrolls the first image series left, tight, up or down
